(19) United States
(12) Patent Application Publication
(10) Pub. No.: US 2004/0042852 A1
(43) Pub. Date: Mar. 4, 2004

(54) Energy generation system

(76) Inventor: Moshe Alperon, Givat Shmuel (IL)

Correspondence Address: MOSHE ALPERON, 3 BEN YOSSEF ST, GIVAT SHMUEL, 54017, IL

(21) Appl. No.: 10/241,637

(22) Filed: Sep. 12, 2002

(30) Foreign Application Priority Data
Sep. 4, 2002 (IL) 151591

(51) Int. Cl. E01C 7/00

(52) U.S. Cl. 404/71

(57) ABSTRACT

A system for generating energy on the road, from the vehicles movement on the road, comprises a driving cylinder laid across the road in such a way that vehicles pass over it, an electrical generator for generating electricity when its axis is rotated, and a transmission unit for transferring rotational motion from the driving cylinder to the generator axis. The electrical generator comprises a large generator for an electrical power station or a small generator for local consumption. The transmission unit includes a gear system for increasing the rotation speed.

### CROSS-REFERENCE TO RELATED APPLICATIONS

The present application claims priority from my patent application having the same title, Application No. 151591 filed on Sep. 4, 2002 with the Patent Office in Jerusalem, Israel.

### FIELD OF THE INVENTION

My invention relates to systems for generating energy on the road, from the vehicles movement on the road.

### BACKGROUND OF THE INVENTION

As it is known, there is a worldwide problem with energy. The consumption of energy grows all the time, whereas the energy resources such as oil—are limited.

Thence the importance of systems for energy generation or energy saving.

Part of the energy is lost during the process of transferring electricity from one place to another, from the power station to the consumers. There is a benefit in generating electricity at a place closer to the consumers.

Large amounts of energy are wasted in illuminating roads at night. This illumination is important when there is vehicles traffic, to decrease the danger of car accidents, for example. Nevertheless, at times there is no traffic on the road, and electricity is wasted to no purpose.

Yet another contemporary problem relates to payments processing at toll roads. At present, there are roads wherein payment is demanded of travelers there. One method uses payment stations. Each car has to stop in order to pay there.

Another expense incurred is in personnel for receiving those payments.

### SUMMARY OF THE INVENTION

The present invention allows to generate electrical energy from the vehicles movement on the road.

According to one embodiment of the invention, a driving cylinder is laid across the road. Each car passing over it, causes the cylinder to rotate, and to the generation of electrical energy.

The electrical energy may find various uses. A large generator may be installed, for an electric power station.

In another embodiment, a small generator can supply electricity to a village, a town or road installations.

In another embodiment, the electricity can be used for local road illumination, such as to provide illumination only when this is required—when there is traffic in that location.

The electricity is used locally, this preventing the losses associated with energy transfer to another location.

Actually, the energy is generated at the expense of the vehicle's energy, and this may be used as a method for automatic payment on toll roads. The payment is immediate, with not need to stop the vehicle.

Vehicles having more than 4 wheels will pay more. Vehicles traveling faster will pay more.

Thus, in the new method the payment is relative to the measure of use of the road by the vehicle.

### BRIEF DESCRIPTION OF THE DRAWINGS

My invention will now be described by means of a practical example of one way of carrying it out and with reference to the drawings, in which:

FIG. 1 illustrates a system for energy generation on the road

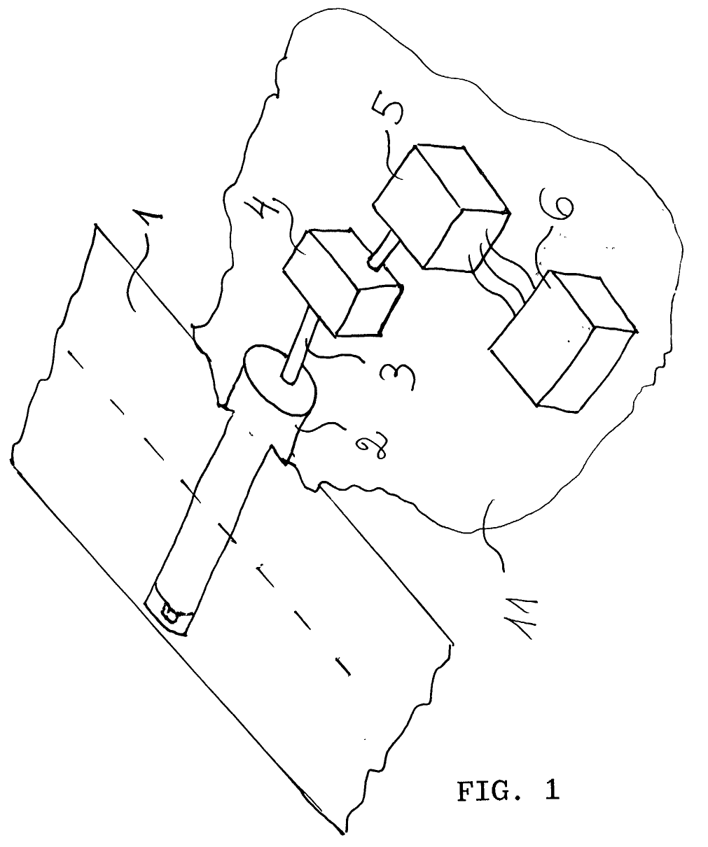

FIG. 2 details the movement transfer to a generator

FIG. 3 details another embodiment of the system

FIG. 4 details the driving cylinder

FIG. 5 details a system with a plurality of driving cylinders

FIG. 6 details the structure of a driving cylinder with supports

### DETAILED DESCRIPTION OF THE PREFERRED EMBODIMENTS

Following are examples of my invention, with reference to the attached drawings.

In a space 11 on the road 1, a driving cylinder 2 is installed, such that the passage of a vehicle on the road 1 over the cylinder 2 will cause the cylinder 2 to rotate.

The cylinder axis 3 is connected to a transmission system 4, and through it to an electrical generator 5.

The electrical energy generated in generator 5 can find various uses. The voltage can be changed as desired using a transformer 6.

In another preferred embodiment, the driving cylinder 2 has a diameter of about 12″ (inch) and protrudes about 3 cm (centimeter) above the road level. The height of cylinder 2 relative to the road level can be adjusted, to generate the desired amount of energy from each vehicle—as the cylinder's height is increased, so it is expected that more energy is extracted off each vehicle.

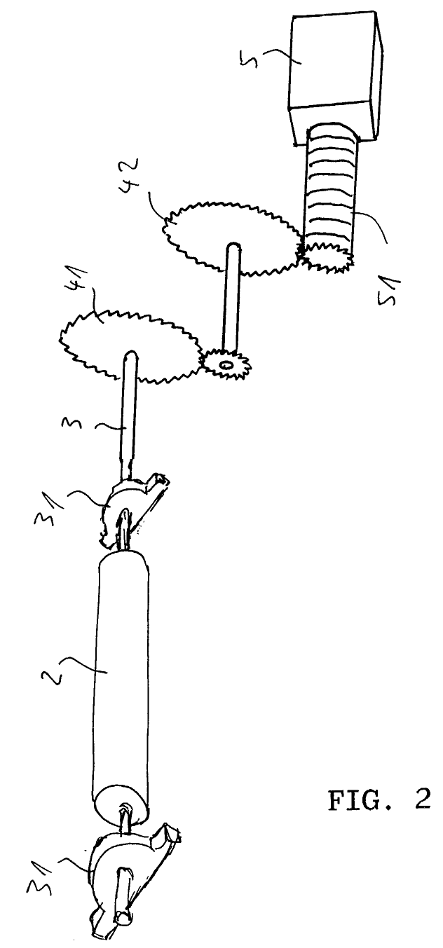

In FIG. 2, the driving cylinder 2 is held by two supports 31, which hold the axis 3 by means of ball bearings for example. The supports 31 can be implemented with omega bearings.

The gear wheels 41, 42 system can either increase or decrease the angular velocity, according to engineering considerations, to generate the maximal—or the desired specific amount of energy from each vehicle.

For example, each pair of gear wheels can use one large wheel having a diameter of 27 cm and a small wheel of diameter 3 cm. In this case, each gear wheels pair will increase the rotational velocity 9 times, and the whole gear wheel system will increase the rotational velocity 81 times.

The output of the gear wheels is connected through axis 51 to the generator 5, which is used to generate electrical energy.

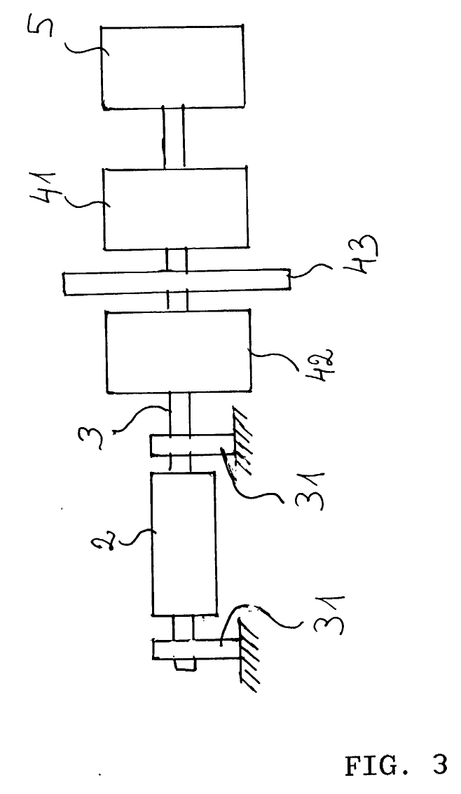

In FIG. 3, the driving cylinder 2 is coupled through axis 3 to an unidirectional coupler system 42, to an inertia wheel 43.

Thus, the rotation of cylinder 2 by a passing vehicle will cause the rotation of the inertial wheel 43. The inertial wheel 43 will continue to rotate, even though the cylinder 2 may stop or may rotate in the reverse direction.

The rotational motion of the inertial wheel 43 is transferred, through the gear system 41, to the electrical generator 5, to generate electrical energy.

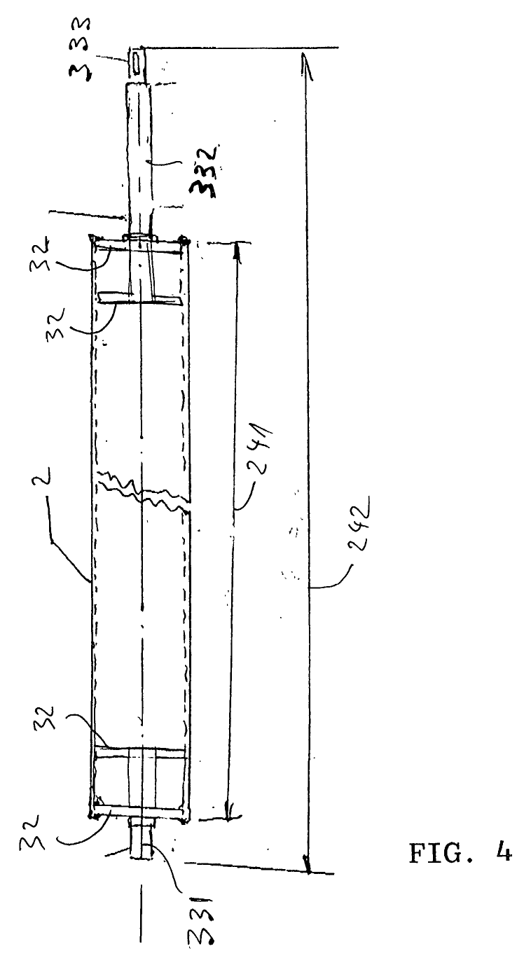

FIG. 4 details another embodiment of the invention. A driving cylinder 2 implemented as a pipe having a 12″ diameter, for example, is connected to axis 3 using disks 32, a pair of disks at each end of the pipe.

The distance between the disks on each side may be 20 to 30 cm, for example. Thus the axis 3 is secured to the driving cylinder 2 in a structure of high mechanical strength, without the axis 3 having to pass along the whole length of the pipe. Thus a light weight and strong structure is achieved.

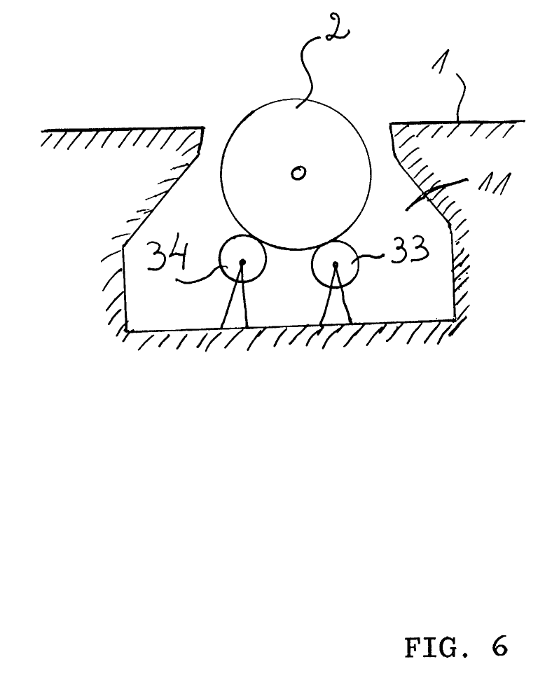

The length 241 can be 3 m (meter) to 6 m, for example. It is possible to install support means under the cylinder 2, to support the load when a heavy vehicle passes over it. For example, it is possible to put a support in the middle of the length 241 (see also FIG. 6), using bearings or wheels, for example.

Rather than using a pipe of circular cross section, a pipe having a multi-faceted polygon may be used, for example a hexagon or a pentagon or any other form.

If the pipe cross section is not circular, it is possible to create a circular part therein, in the place where a support is mounted under the cylinder as detailed above. In this case, if there is a support under the part 241, then the whole of the pipe is hexagonal, for example, except for a portion in the middle of the cylinder, which has a round cross section.

In the above example, a preferred total length 242 is about 3.66 m. The axis 3 contains two parts, the left side part 331 and the right side part 332.

The left side part 331 may have a diameter of about 40 mm (millimeter) and a length of about 60 mm.

The right side part 332 may have a diameter of about 40 mm and a length of about 600 mm, with a portion 333 at its end, having a length of about 30 mm and a diameter of about 38 mm.

It is preferred to manufacture a portion of axis having a different diameter, so that the bearing can better hold the axis.

If it is desired to lay a cylinder 2 over a broad road, for example a road of 12 meter width, then two or more cylinder parts may be used, with a rotary joint between them. This solves the stringent requirement for a long structure having axial symmetry and mechanical strength—using several parts. Each cylindrical part can be held with a pair of supports with bearings, one support on each side of each cylinder.

In a preferred embodiment, the driving cylinder is coated with an anti-skidding material, to prevent or reduce slipping.

In another embodiment, the cylinder has a measure of asperity, to reduce the amount of slipping of the vehicle wheel relative to it.

In a preferred embodiment, the gear wheel has a smaller diameter than that of the driving cylinder 2, in such a way as to enable its efficient installation under the road. The long axis 332, having a length of about 0.5 to 1.4 m, allows to install the generator at the side of the road, further from the vehicles traffic.

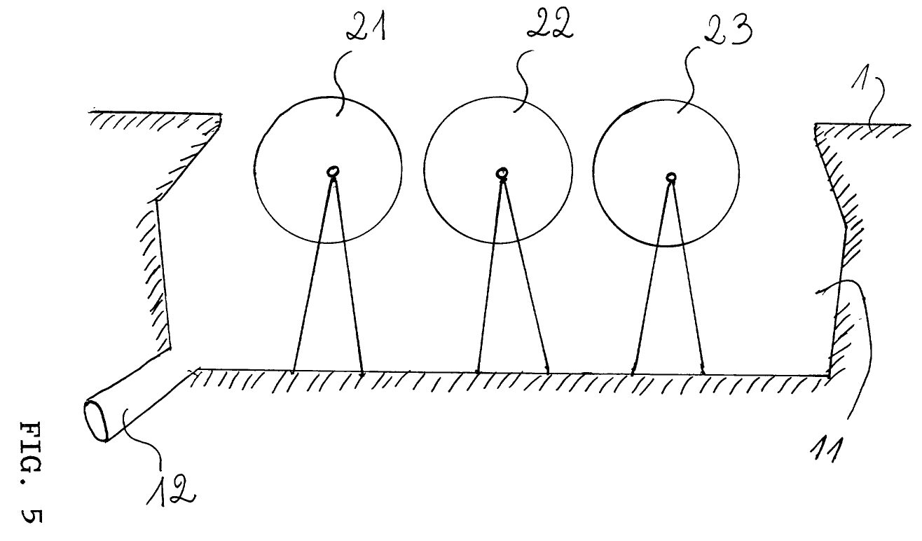

FIG. 5 details a system with a plurality of driving cylinders 21, 22, 23. There are three cylinders in the example as shown.

The cylinders are laid under the road 1, in a space 11. In a preferred embodiment, the space 11 is formed of walls made of concrete or metal. A drain pipe 12 can be installed to remove water accumulating from rain, for example.

Each driving cylinder can be connected to its own generator.

In another embodiment, all the cylinders can be connected to a common axis, through unidirectional coupling, in such a way that the fastest rotating cylinder will drive the generator, at any given moment.

FIG. 6 details the structure of a driving cylinder 2 with mechanical supports implemented as wheels or bearings 33, 34.

Several such supports may be installed along the cylinder 2, to support it in several locations, to hold the weight of a vehicle passing on the road over the system.

In a preferred embodiment, a pair of bearings 33, 34 is installed in the middle of the driving cylinder 2.

The above description is just one example of my invention. Various ways of implementing the invention will occur to persons skilled in the art upon reading the above disclosure and/or implementing the invention.

What is claimed is:

1. A system for generating energy on the road, from
a vehicles movement on the road, comprising a driving cylinder laid across the road in such a way that vehicles pass over it, an electrical generator for generating electricity when its axis is rotated, and a transmission unit for transferring rotational motion from the driving cylinder to the generator axis.

2. The system according to claim 1, wherein the electrical generator comprises a large generator for an electrical power station.

3. The system according to claim 1, wherein the transmission unit includes a gear system for increasing the rotation speed.

4. The system according to claim 3, wherein the gear system includes means for increasing the rotation speed about 81 times.

5. The system according to claim 1, further including an unidirectional coupling unit between the driving cylinder and the electrical generator.

6. The system according to claim 1, further including an inertia wheel between the driving cylinder and the electrical generator.

7. The system according to claim 1, wherein the driving cylinder is made of a hollow pipe.

8. The system according to claim 7, wherein the driving cylinder includes a rotation axis going out of each of its ends, and wherein the rotation axis has a smaller diameter than that of the driving cylinder.

9. The system according to claim 7, wherein the hollow pipe has a diameter of about 12″.

10. The system according to claim 7, wherein the hollow pipe has a length of about 6 meter.

11. The system according to claim 7, wherein the axis of rotation has a diameter of about 40 mm.

12. The system according to claim 7, wherein the driving cylinder has a circular cross section.

13. The system according to claim 7, wherein the driving cylinder has a hexagonal cross section.

14. The system according to claim 7, wherein the driving cylinder has a pentagon-shaped cross section.

15. The system according to claim 1, wherein the driving cylinder has support means installed under the cylinder.

16. The system according to claim 15, wherein the support means includes a pair of bearings installed at the middle of the driving cylinder.
